(19) United States
(12) Patent Application Publication
(10) Pub. No.: US 2026/0284689 A1
(43) Pub. Date: Sep. 24, 2026

(54) SELF-ERECTING WATERING DEVICE

(71) Applicant: Fire and Rescue Innovation Finland FRIF Oy, Suonenjoki (FI)

(72) Inventor: Marko Hassinen, Suonenjoki (FI)

(21) Appl. No.: 19/570,600

(22) Filed: Mar. 18, 2026

(30) Foreign Application Priority Data
Mar. 19, 2025 (EP) 25164831

(51) Int. Cl. B05B 15/74; B05B 15/625

(52) U.S. Cl. CPC B05B 15/74; B05B 15/625

(57) ABSTRACT

A self-erecting watering device includes a pipe fitting (10), a water distributor (20) for spraying water, and a conduit between the two. The device further includes two or more support legs (32a, 32b) movable between a closed position and an open position, and an actuator (40) attached to the two or more support legs (32a, 32b) for moving the two or more support legs (32a, 32b) from the closed position to the open position.

### FIELD OF THE INVENTION

The invention relates to devices for controlling wildfires and ground fires, and especially the invention relates to self-erecting watering devices for such a purpose.

### PRIOR ART

Extreme weather conditions are occurring more frequently than before. Prolonged periods of abnormally dry weather increase the risk of wildfires and a wildfire during a severe drought often causes widespread and devastating damages. Once a wildfire has had the time to spread spontaneously, it is next to impossible to extinguish. Such a wildfire can at best be controlled to prevent it from spreading into urban areas.

A well-known way is to water the ground on a wide enough band to prevent fire from spreading across the watered area. The watered band has to be hundreds of meters or thousands of meters long to be effective and it has to be put in place quickly. A set of sprinklers with overlapping spraying areas can create a continuous, watered band on the ground, but there are some difficulties. Firstly, the watered band on the ground must be continuous without any dry strips running across the band. If there is a dry route across the band, the fire will spread across the band. The spraying area of the sprinklers may turn out to be considerably smaller in practice than in theory. For example, a single sprinkler in a suboptimal position may leave a dry route through the otherwise watered band. A single sprinkler partially covered by shrubs or undergrowth in general may have the same effect. Secondly, the sprinklers have to be set-up quickly as time is of the utmost importance when fighting against fires. There is not enough time to build any fixed structures to raise or support the sprinklers as the spreading wildfire may change its course suddenly.

### BRIEF DESCRIPTION OF THE INVENTION

An object of the invention is to develop a device and which solves or at least alleviates the afore-mentioned problems. The object of the invention is achieved with a self-erecting watering device of claim 1. Preferred embodiments of the invention are presented in the dependent claims 2 to 15.

### BRIEF DESCRIPTION OF FIGURES

The invention is now described in more detail in view of preferred embodiments by referring to figures in which:

FIG. 1 illustrates an embodiment of a self-erecting watering device having its support legs in an open position;

FIG. 2 shows the embodiment of FIG. 1 seen from a different viewing angle;

FIG. 3 illustrates an embodiment of a self-erecting watering device having its support legs in a closed position; and

FIG. 4 shows the embodiment of FIG. 3 seen from a different viewing angle.

### DETAILED DESCRIPTION OF THE INVENTION

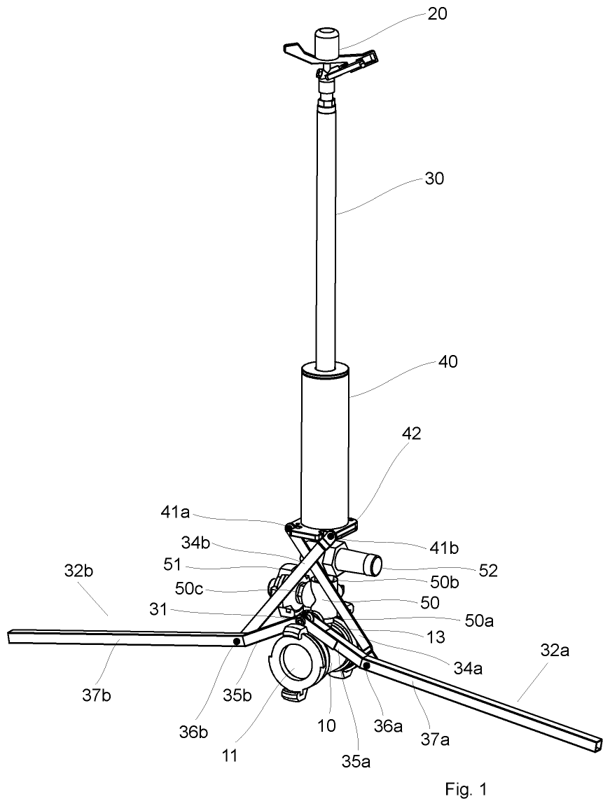

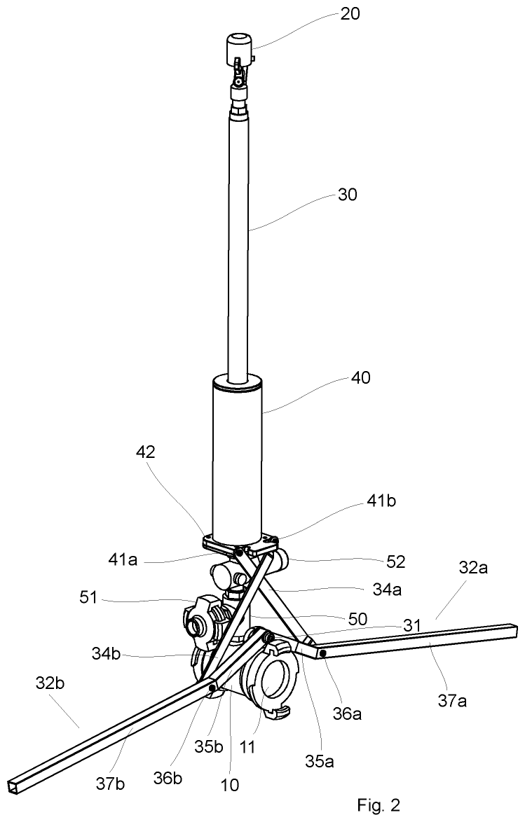

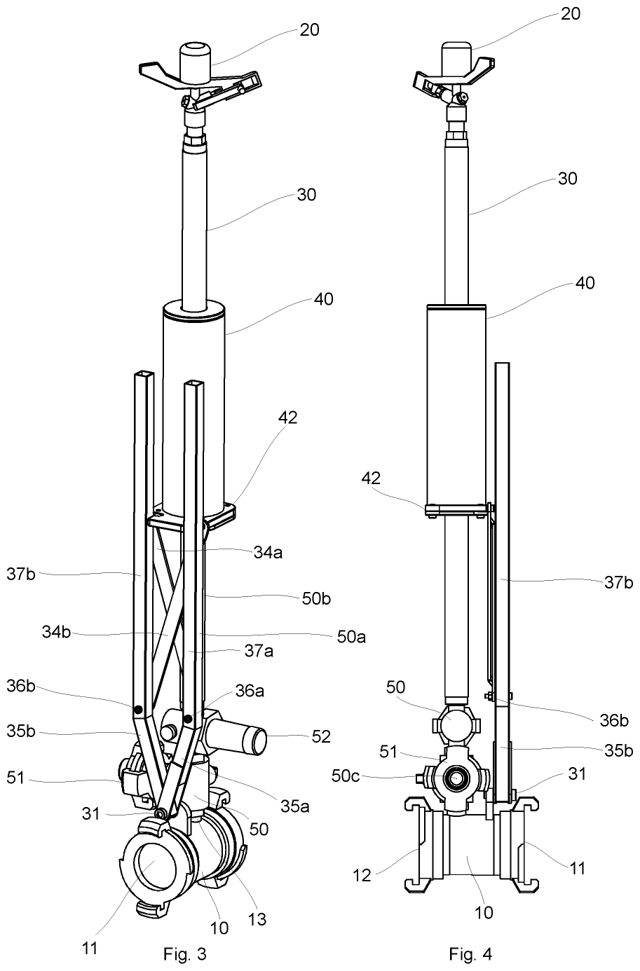

The invention concerns a self-erecting watering device illustrated in FIGS. 1 to 4. Such a device can be used, for example, in controlling wildfires and ground fires by using a plurality of such devices with a small enough spacing to water an elongated, continuous area of ground which the fires cannot spread over.

The self-erecting watering device comprises a pipe fitting 10 that is preferably arranged to be one of the lowermost parts of the device in an erect position of the device. The pipe fitting has at least a supply line inlet 11, a supply line outlet 12 and a distributor outlet 13. Water is supplied to the device using a water hose connected to the supply line inlet 11 and another water hose is connected to the supply line outlet 12 for supplying water for subsequent device, which then supplies water for the subsequent device, and so on. The first device of the line must of course be connected to a pressurized water source by a water hose. The pipe fitting 10 is preferably equipped with hose couplings on the supply line inlet and the supply line outlet. The couplings are preferably compatible with fire hoses commonly used in the area where the devices are being used on. For example, in many areas of Europe, claw couplings are commonly used, whereas National Hose/National Standard Thread (NH/NST) couplings are commonly used in North America. Preferably the supply line inlet and the supply line outlet are opposite to each other in the pipe fitting and they both have the same size or diameter. The distributor outlet 13 is used for distributing water with the device. The distributor outlet is preferably facing in a direction perpendicular to the supply line inlet and the supply line outlet. Preferably the distributor outlet faces upwards when the device is in the erect position. The distributor outlet is preferably smaller in size or diameter than the supply line inlet and the supply line outlet as only a small fraction of the supplied water stream is intended to be distributed via a single watering device.

The watering device also comprises a water distributor 20 for spraying or misting water. The water distributor preferably sprays water in the form of relatively large droplets while simultaneously producing fine droplets forming mist into the surrounding air. The water distributor can also be a single mode sprinkler device mostly distributing water in relatively large droplets or a single mode misting device mostly distributing water in relatively small droplets. In an embodiment, the water distributor is a dual mode spray/mist sprinkler which can be configured to distribute the water in either large droplets or small droplets. The device has a conduit between the distributor outlet 13 of the pipe fitting 10 and the water distributor 20 for conveying water from the pipe fitting 10 to the water distributor 20. The conduit can be formed by a single part, such as a pipe, or by multiple parts, such as pipes, pipe fittings, regulators, etc attached to one another in a way that allows water to flow through the conduit. In an embodiment, the device comprises a rigid tube 30 between the distributor outlet 13 of the pipe fitting and the water distributor 20, thereby the rigid tube defines at least part of the conduit. The water distributor 20 is preferably the part of the device that is furthest from the ground when the device is in its erect position on the ground.

The self-erecting watering device further comprises two or more support legs 32a, 32b. In a preferred embodiment there are two support legs as shown in FIGS. 1 to 4 but also three support legs or four support legs can be used. The support legs are movable at least between a closed position and an open position and preferably also between the open position and the closed position. The device is preferably configured to move into the erect position as a consequence of the support legs moving from the closed position to the open position. However, the device may not have any predetermined or predictable position when the support legs are in the closed position. Preferably, the two or more support legs in the closed position are parallel or at least substantially parallel to the conduit, or parallel to a direction passing the end points of the conduit if the conduit does not follow a straight line.

In a preferred embodiment of the invention, the two or more support legs 32a, 32b in the open position are perpendicular or at least substantially perpendicular to a line defined by the centre points of the supply line inlet 11 and the supply line outlet 12 of the pipe fitting 10. This embodiment is particularly useful as the device can be positioned in all three orthogonal directions (X-Y-Z) with the afore-mentioned setup. The pipe fitting 10 having water supply hoses connected to the supply line inlet and the supply line outlet define two of the three axes. Firstly, the water hoses filled with water under pressure are relatively heavy but also substantially rigid as the water pressure forces the water hoses to essentially follow a straight line. The water hoses lie against the ground in an essentially straight line which also forces the supply line inlet and the supply line outlet to align with that straight line. We shall call the direction of water hoses X-axis. The weight of the water in the water hoses combined with the rigidity of the pressurized water hoses and gravity pulls the pipe fitting 10 downwards, i.e. towards the ground. The direction of this force is perpendicular to the X-axis, and we shall call it Y-axis. The Z-axis is stabilized by the support legs in their open position. The support legs in the open position being perpendicular to the line defined by the centre points of the supply line inlet and the supply line outlet means that the support legs are perpendicular to the X-axis defined earlier. Distant ends of the support legs are preferably the lowermost part of the device, extending slightly lower than the pipe fitting. This means, at least on a substantially even ground, that the distant ends of the support legs are in contact with the ground in their open position. Preferably, the pipe fitting is raised just above the ground by the support legs 32a, 32b moving from their closed position to their open position. Especially when the pipe fitting 10 is one of the lowermost parts of the device when the support legs are in the open position, the force of gravity forces the device to the erect position because of the relatively heavy weight of the pipe fitting and the water hoses attached to it, compared to the rest of the device. Thus, the device is self-erecting. The situation described here does not change meaningfully if the support legs are not perfectly perpendicular, but merely substantially perpendicular, to the line defined by the centre points of the supply line inlet and the supply line outlet of the pipe fitting. If the angle is, for example 80 degrees, the component in the perpendicular direction is still almost the same as in the perfectly perpendicular case of the 90-degree angle.

The device further comprises an actuator 40 attached to the two or more support legs 32a, 32b for moving the two or more support legs from the closed position to the open position. The actuator is crucial for the self-erecting feature as it ensures that no human interaction is needed directly with the device in order to move the device into its erect position. The actuator can be a passive actuator, such as a tensioned spring, or an active actuator, such as an electric actuator, pneumatic actuator or hydraulic actuator. When a tensioned spring is used as the actuator, the spring has to be manually pre-tensioned before intended use, for example during assembly or preparation of the device. When an electric actuator is used, the device may comprise a battery or a similar energy source to power the electric actuator. When a pneumatic actuator is used, the device may comprise a pressure vessel containing compressed air or a similar energy source to power the pneumatic actuator.

In a preferred embodiment, the actuator 40 is a linear actuator because the movement of the support legs between the closed position and the open position is linear. The actuator can also be a non-linear actuator, such as a rotary actuator and the device further comprises means for transforming a rotary motion of the actuator into a linear motion of the support legs. The support legs may also be designed in such a way that the type of movement between the closed position and the open position of the support legs is rotary motion. An example of a passive linear actuator is a tensioned coil spring. Examples of active linear actuators are electric linear actuators, pneumatic linear actuators and hydraulic linear actuators. Any actuator type can be set to be activated automatically in the presence of water or pressure, for example, in the conduit of the device. The actuator could also be activated manually by, for example, removing a cotter pin when the device is deployed on the ground.

The type of actuator used in the device is preferably a hydraulic actuator and more preferably a hydraulic linear actuator. The hydraulic actuator is preferably in fluid communication with the conduit of the device, and configured to convert hydraulic pressure within said conduit to a linear motion. A benefit of this embodiment is that the hydraulic pressure of the water supplied to the device can be utilized to power the actuator and other external energy sources are not needed. Compared to the passive linear actuator, such as a tensioned coil spring, the hydraulic actuator requires no preparation and does not lose its functionality during a prolonged storage time. Preferably the hydraulic actuator is a hydraulic cylinder that uses pressurized fluid, i.e. water in this case, to generate force and motion. Hydraulic actuators are preferred because they are capable of producing relatively high forces and are very reliable and durable.

In an embodiment, the actuator 40 comprises a first part and a second part movable in relation to the first part. The first part of the actuator is fixed to the rigid tube and the second part is pivotably attached to the two or more support legs 32a, 32b. The actuator in this case is preferably a hydraulic linear actuator such as a hydraulic cylinder. The first part can be a piston of the hydraulic cylinder or the cylinder. In an embodiment, the device comprises a rigid tube 30 that defines at least part of the conduit but also functions as part of the piston of the hydraulic cylinder. When pressurized water flows into the cylinder of the hydraulic cylinder type actuator, the cylinder and the piston move relative to each other. Now if the piston is fixed to the device, the cylinder moves in relation to the first part of the actuator. This type of embodiment is illustrated in FIGS. 1 to 4 as one practical example of the device. The second part, that is the movable part, of the actuator preferably has one or two or more pivot points 41a, 41b for pivotally attaching the two or more support legs to the second part of the actuator. The pivot points can be arranged to the second part of the actuator by having a plate 42 fixed to the second part where the plate has through holes or some other forms that can be used as the pivot points. The pivot points can also be arranged directly on the second part of the actuator.

The self-erecting watering device can further comprise two or more guide bars 34a, 34b that can be used for pivotally attaching the support legs 32a, 32b to the second part of the actuator. Each of the two or more support legs can be pivotably attached to a first end of a guide bar, where a second end of the guide bar, opposite to the first end of the guide bar, can be pivotably attached to a movable part of the actuator. In an embodiment, the second ends of the guide bars can be pivotably attached to the pivot points 41a, 41b of the plate 42, that is fixed to the second part of the actuator as shown in FIGS. 1 to 4. The guide bars 34a, 34b can pivot both in relation to the support legs and in relation to the second part of the actuator.

Depending on the design of the actuator and the support legs, a very high force may be required in the beginning of the moving the support legs from the closed position to the open position. The force required in the motion can be reduced by having a curve or a bend in the support legs. In a preferred embodiment, each of the support legs 32a, 32b comprises two or more mutually non-parallel straight sections 35a, 37a; 35b, 37b. Each of the support legs has a pivot point 36a, 36b for a guide bar at the area where the two non-parallel straight sections connect to each other. The first end of the guide bar can be pivotably attached to said pivot point 36a, 36b thereby reducing the force required in the beginning of the motion of the support legs. The initial force can be further reduced by pivotably attaching the first ends of the guide bars to the pivot points 36a, 36b of the support legs and having the guide bars cross one another between the first end and the second end of the guide bars. That is, in the embodiment of FIG. 1 for example, the first end of one guide bar 34a is pivotably attached to the support leg 32a on the right-hand side of the device and the second end of the same guide bar 34a is attached to the pivot point 41a on the left-hand side of the device, whereas the other guide bar 34b is attached to the support leg 32b on the left-hand side and to the pivot point 41b on the right-hand side.

In an embodiment, the device comprises two support legs that are pivotably attached to a common pivot point 31 on the device. This is preferably in addition to the pivotable attachment between the support legs and the second part of the actuator. Preferably the two support legs are attached from one of their ends, pivoted ends, to the common pivot point, whereas the opposite ends of the support legs are the distal ends of the support legs that are arranged to be in contact with ground when the support legs are in their open position. In this case, a leverage coefficient is defined the ratio between the distance from the pivoted end of a support leg to the pivot point 36a, 36b of the support leg and the distance from the distal end of the support leg to the pivot point 36 a, 36 b of the support leg. Preferably, the ratio is smaller than 1, meaning that the pivot point 36a, 36b of the support legs is closer to the pivoted end of the support legs than the distal end of the support legs. The ratio being smaller than 1 means that when the second part of the actuator 40 is moved by a certain distance, the distal ends of the support legs move a greater distance. The common pivot point 31 is preferably fixed onto the pipe fitting 10 of the device, but the common pivot point can also be fixed or pivotable attached to some other place on the device. The design and placement of the support legs and possible guide bars and their pivot points dictate suitable locations for the common pivot point.

There is often a need to set up a long chain of the self-erecting watering devices described herein in order to prevent a wildfire or a groundfire from spreading into an unwanted area or direction. A water source providing water for the devices has a certain water pressure which is essentially the water pressure at the supply line inlet of the first device in the chain. As part of water stream entering the device is sprayed and/or misted with the water distributor, the water pressure at the supply line inlet of the second device is smaller. This also means that an effective watering radius of the first device of the chain would be the largest and it would diminish along the chain of devices. To alleviate said drawback, preferably the conduit between the pipe fitting 10 and the water distributor 20 comprises a pressure reducing valve 52 for reducing pressure of water conveyed through the conduit to the water distributor 20. The pressure reducing valve reduces the water pressure to a constant level that is optimal for the water distributor. The pressure reducing valve could be set to, for example, 400 kPa or 500 kPa or to some value in a range from 200 kPa to 800 kPa. This would have the effect of the devices in chain having similar effective watering range up to a point in the chain where the water pressure falls below the pressure set on the pressure reducing valves. The water pressure would also remain higher for further down the chain as the first devices would consume considerably less water than without the pressure reducing valves.

There may also rise a need to use water at some point of the chain of devices. This can be realized with the conduit of the device comprising a three-way valve 50 having an inlet 50a in fluid communication with the distributor outlet 13 of the pipe fitting 10, a first outlet 50b in fluid communication with the water distributor 20, and a second outlet 50c having a hose connector 51 for attaching a hose thereto. Preferably, the hose connector 51 used in the second outlet 50c of the three-way valve is of the same type as the hose connector used in the supply line outlet 12. The three-way valve 50 is preferably located before a pressure reducing valve, if any, in order to provide the maximum water pressure available at the device. With the device having the three-way valve, water can be distributed locally to whatever purpose without breaking the chain of devices by simply diverting the water flow to the hose connector 51 instead of the water distributor 20, or in addition to.

In a preferred embodiment, the self-erecting watering device comprises, in a flow direction of water from the pipe fitting 10 to the water distributor 20, the pipe fitting 10 connected to a three-way valve 50, the three-way valve 50 connected to a pressure reducing valve 52, the pressure reducing valve 52 being also connected to a rigid tube 30, a hydraulic actuator 40 in a fluid communication with the rigid tube 30, and the rigid tube 30 being also connected to a water distributor 20. This set of parts in this order has been found to result the best combination of features for most purposes while still being simple enough for reliable operation.

As technology evolves, a person skilled in the art acknowledges that the basic principle of the invention can be realized in various ways. The invention and its embodiments are not limited to the examples above but can vary within the scope of the claims.

1. A self-erecting watering device comprising
a pipe fitting having a supply line inlet, a supply line outlet and a distributor outlet,
a water distributor for spraying or misting water,
a conduit between the distributor outlet of the pipe fitting and the water distributor for conveying water from the pipe fitting to the water distributor,
two or more support legs movable between a closed position and an open position, and
an actuator attached to the two or more support legs for moving said two or more support legs from the closed position to the open position, where said actuator is a hydraulic actuator in fluid communication with said conduit, and configured to convert hydraulic pressure within said conduit to a linear motion.

2. The self-erecting watering device of claim 1, where said actuator is a linear actuator.

3. The self-erecting watering device of claim 1, where the device further comprises a rigid tube between the distributor outlet of the pipe fitting and the water distributor, the rigid tube defining at least part of the conduit.

4. The self-erection watering device of claim 3, where the actuator comprises a first part and a second part movable in relation to the first part, wherein the first part of the actuator is fixed to the rigid tube and the second part is pivotably attached to the two or more support legs.

5. The self-erecting watering device of claim 1, where said two or more support legs in the closed position are parallel or at least substantially parallel to said conduit.

6. The self-erecting watering device of claim 1, where said two or more support legs in the open position are perpendicular or at least substantially perpendicular to a line defined by the centre points of the supply line inlet and the supply line outlet of the pipe fitting.

7. The self-erecting watering device of claim 1, wherein the conduit comprises a pressure reducing valve for reducing pressure of water conveyed through the conduit to the water distributor.

8. The self-erecting watering device of claim 1, wherein the conduit comprises a three-way valve having an inlet in fluid communication with the distributor outlet of the pipe fitting, a first outlet in fluid communication with the water distributor, and a second outlet having a hose connector for attaching a hose thereto.

9. The self-erecting watering device of claim 1, wherein the device comprises, in a flow direction of water from the pipe fitting to the water distributor, the pipe fitting connected to a three-way valve, the three-way valve connected to a pressure reducing valve, the pressure reducing valve being also connected to a rigid tube, a hydraulic actuator in fluid communication with the rigid tube, and the rigid tube being also connected to a water distributor.

10. The self-erecting watering device of claim 1, wherein the device further comprises two or more guide bars, each of the two or more support legs being pivotably attached to a first end of a guide bar, where a second end of the guide bar, opposite to the first end of the guide bar, is pivotably attached to a movable part of the actuator.

11. The self-erecting watering device of claim 1, wherein each of the support legs comprises two or more mutually non-parallel straight sections, where each of the support legs have a pivot point for a guide bar at the connection of the two non-parallel straight sections.

12. The self-erecting watering device of claim 10 wherein the first ends of the guide bars are pivotably attached to the pivot points for the guide bar of the support legs, where the guide bars cross one another between the first end and the second end of the guide bars.

13. The self-erecting watering device of claim 1, wherein the device comprises two support legs pivotably attached to a common pivot point.

14. The self-erecting watering device of claim 13, wherein the common pivot point is fixed onto the pipe fitting.
